(19) United States
(12) Patent Application Publication
(10) Pub. No.: US 2004/0158511 A1
(43) Pub. Date: Aug. 12, 2004

(54) Accounting management apparatus and accounting process method

(75) Inventors: Kazuhiro Ichikawa, Nagano-ken (JP); Osamu Ishibashi, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/690,970

(22) Filed: Oct. 23, 2003

(30) Foreign Application Priority Data
Oct. 23, 2002 (JP) 2002-308262

(51) Int. Cl. G06F 17/60

(52) U.S. Cl. 705/30

(57) ABSTRACT

The system of the invention multiplies a base unit price with regard to each size of printing paper by a unit price coefficient of a toner cartridge, so as to set an accounting unit price with regard to the size of printing paper. Here the unit price coefficient of the toner cartridge is calculated as a product of component unit price coefficients. Each of the component unit price coefficients is set to have a smaller value with an increase in frequency of reuse with regard to the corresponding component of the toner cartridge. The system then multiplies a number of prints with regard to each size of printing paper by the setting of the accounting unit price to compute a charge for use of a toner filled in the toner cartridge. The user accordingly desires to use a toner cartridge made of frequently reused components. This arrangement thus encourages reuse of the respective components of the toner cartridge, thereby contributing to effective utilization of resources.

### BACKGROUND OF THE INVENTION

1. Field of the Invention

The present invention relates to an accounting management apparatus and an accounting process method. More specifically, the invention relates to an accounting management apparatus that manages accounting with respect to image formation by an image formation device, which uses a recording agent from a recording agent cartridge having a storage element to form an image including letters and characters on a medium like paper, and an accounting process method executed by the accounting management apparatus.

2. Description of the Prior Art

A proposed accounting management apparatus computes a charge with regard to use of a toner supplied in the form of a toner cartridge, based on information regarding the number of prints (for example, Patent Application Gazette No. 2001-305920). This proposed apparatus causes a printer connecting with the accounting management apparatus via a communication line to read out and send information regarding the number of prints, which is stored in a storage element of a toner cartridge attached to the printer. The accounting management apparatus accordingly acquires the information regarding the number of prints and computes the charge, based on the acquired information regarding the number of prints and the specification of a contract with each user.

Reuse and recycle of various products have been promoted from the viewpoint of effective utilization of resources. There is a high demand for reuse of a recording agent cartridge, which supplies a recording agent, such as a toner, and is used for an image formation device like a printer. The reuse rate of the recording agent cartridge is heightened by judging the reusability of each component of a collected cartridge and replaces each non-reusable component according to the requirement to allow for reuse of the cartridge. The reused recording agent cartridge naturally has a lower unit price than the unit price of a brand new recording agent cartridge. The prior art accounting management apparatus, however, computes the charge in a similar manner for the brand new recording agent cartridge and the reused recording agent cartridge. The user accordingly desires to use the brand new recording agent cartridge. This prior art system does not encourage reuse of the recording agent cartridge.

### SUMMARY OF THE INVENTION

One object of the accounting management apparatus and the accounting process method of the invention is to encourage reuse of a recording agent cartridge. Another object of the accounting management apparatus and the accounting process method of the invention is to take into account reuse of a recording agent cartridge for accounting of a charge.

To achieve at least a part of aforementioned objects, an accounting management apparatus and an accounting process method of the resent invention are structured as follows.

An accounting management apparatus of the present invention is an apparatus that manages accounting with respect to image formation by an image formation device, which uses a recording agent from a recording agent cartridge having a storage element to form an image including letters and characters on a medium like paper, the accounting management apparatus including: an information acquisition module that acquires accounting information which is stored in the storage element of the recording agent cartridge, the accounting information including cartridge information with regard to the recording agent cartridge and image formation information with regard to image formation carried out by the image formation device with the recording agent from the recording agent cartridge; and a charge computation module that computes a charge, based on the acquired cartridge information and image formation information.

The accounting management apparatus of the invention computes the charge, based on the cartridge information with regard to the recording agent cartridge, which is stored in the storage element of the recording agent cartridge, and the image formation information with regard to image formation by the image formation device. This arrangement ensures reflection of the information regarding the recording agent cartridge on the accounting.

In the accounting management apparatus of the invention, as one aspect, the cartridge information may include reuse information regarding reuse of a main body and components of the recording agent cartridge, and the charge computation module may compute the charge, based on the reuse information. In this case, the charge computation module may compute the charge in such a manner as to lower the charge with an increase in frequency of reuse with regard to the main body of the recording agent cartridge. Further in this case, the charge computation module may compute the charge in such a manner as to lower the charge with an increase in number of reused components among all the components of the recording agent cartridge.

In the accounting management apparatus of the invention, as another aspect, the image formation information may include a numerical quantity of image formation, and the charge computation module may compute the charge in such a manner as to lower the charge with an increase in numerical quantity of image formation.

In the accounting management apparatus of the invention, as still another aspect, the information acquisition module may acquire the image formation information from the storage element of the recording agent cartridge.

The accounting management apparatus of the invention, as still another aspect, may further include a connector module that is connectable with the storage element of the recording agent cartridge, and the information acquisition module may acquire information used for accounting from the storage element of the recording agent cartridge connecting with the connector module.

In the accounting management apparatus of the invention, as still another aspect, the information acquisition module may acquire the cartridge information and the image formation information, which are stored in the storage element of the recording agent cartridge attached to the image formation device, from the image formation device connecting with the accounting management apparatus via a communication line. In this case, the multiple recording agent cartridges may be attached to the image formation device, and the charge computation module may compute the charge, based on multiple pieces of the cartridge information acquired from respective storage elements of the multiple recording agent cartridges attached to the image formation device.

The technique of the present invention is not restricted to the accounting management apparatus described above, but is also applicable to an accounting process method with the accounting management apparatus.

### BRIEF DESCRIPTION OF THE DRAWINGS

FIG. 1 schematically illustrates the construction of an accounting management apparatus 20 in one embodiment of the present invention;

FIG. 2 is a block diagram of the accounting management apparatus 20;

FIG. 3 shows one example of the appearance of the toner cartridge 40;

FIG. 4 schematically illustrates the structure of the color laser printer 60;

FIG. 5 shows one example of a sectional view showing a cross section of the toner cartridge 40;

FIG. 6 shows one example of the information stored in the storage element 50;

FIG. 7 is a flowchart showing an accounting process routine;

FIG. 8 shows one example of the component unit price coefficient;

FIG. 9 shows one example of the resulting charges; and

FIG. 10 illustrates one example of an accounting management system.

### DESCRIPTION OF THE PREFERRED EMBODIMENTS

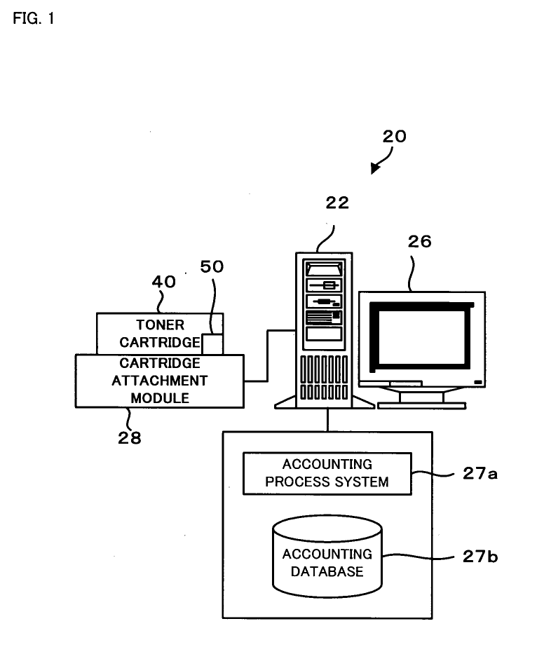

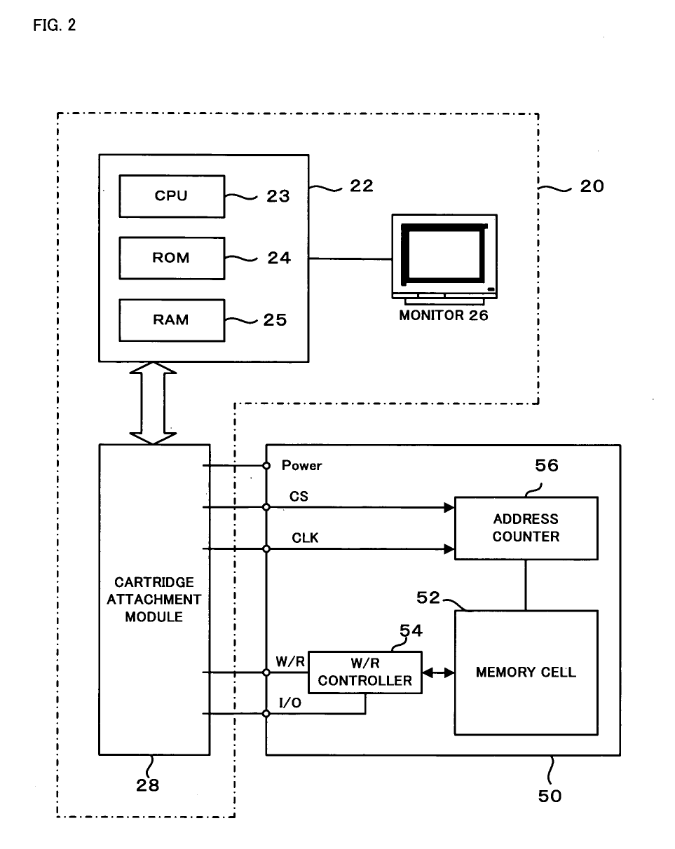

One preferred embodiment of the invention is discussed below. FIG. 1 schematically illustrates the construction of an accounting management apparatus 20 that takes charge of an accounting process with regard to printing by a color laser printer 60 functioning as an image formation device in one embodiment of the invention. FIG. 2 is a block diagram showing electrical connection of functional blocks in the accounting management apparatus 20 of the embodiment. As shown in FIGS. 1 and 2, the accounting management apparatus 20 of the embodiment includes a general-purpose computer assembly 22 having a CPU 23, a ROM 24, a RAM 25, and a non-illustrated input-output interface, a monitor 26 that is connected with the computer assembly 22, and a cartridge attachment module 28 that is connected with the computer assembly 22 via the non-illustrated input-output interface and receives a toner cartridge 40 attached thereto. The accounting management apparatus 20 reads information with regard to reuse of the toner cartridge 40 and information with regard to printing from a storage element 50 of the toner cartridge 40 attached to the cartridge attachment module 28, and carries out an accounting process with respect to printing with the toner cartridge 40. An accounting process system 27a that executes the accounting process with respect to printing with the toner cartridge 40 and an accounting database 27b that stores the information read from the storage element 50 in the form of a database and data required for the accounting process are installed in the computer assembly 22.

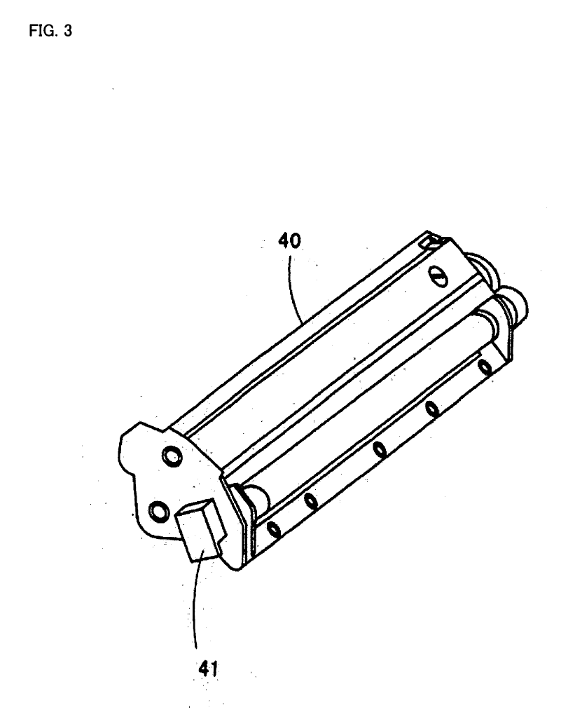

As shown in FIG. 2, the storage element 50 has a memory cell 52 that stores data therein, a read-write controller 54 that controls operations of reading and writing data from and into the memory cell 52, and an address counter 56 that counts up the address in response to a clock signal CLK in the course of data transmission to and from the accounting management apparatus 20 of the embodiment and a controller of the color laser printer 60 (discussed later) via the read-write controller 54. An EEPROM is a typical example of the storage element 50. FIG. 3 shows the appearance of the toner cartridge 40. As illustrated, the toner cartridge 40 of the embodiment has the storage element 50 set inside a holder 41, which is attached to one end of the toner cartridge 40.

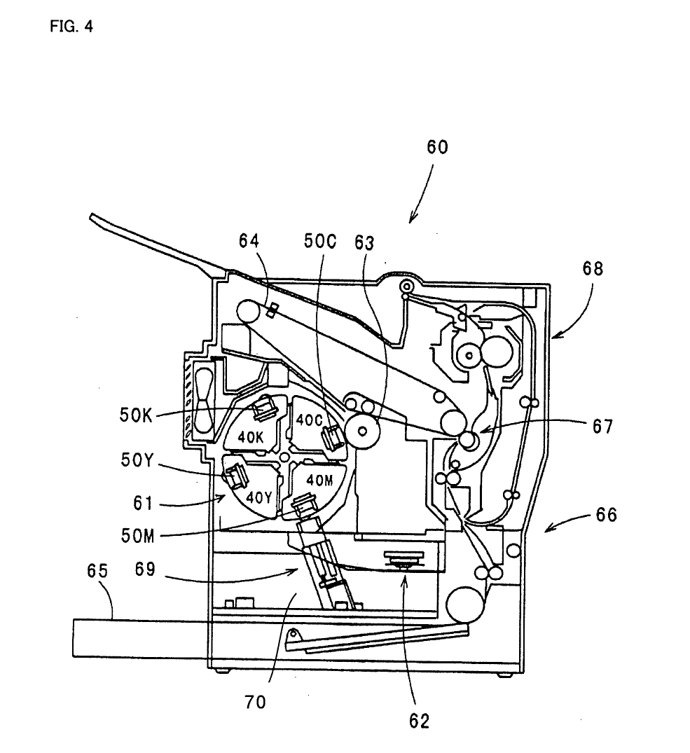

FIG. 4 schematically illustrates the structure of the color laser printer 60 with the toner cartridge 40 attached thereto. The color laser printer 60 with the toner cartridge 40 attached thereto is constructed as a full-color electrophotographic image formation device that adopts a single photoreceptor system and an intermediate transfer system. An original color image is subjected to color separation into four color image components of cyan (C), magenta (M), yellow (Y), and black (K). As shown in FIG. 4, the system creates electrostatic latent images of the respective color image components on a photoreceptor 63 by means of an exposure unit 62, forms color toner images on the electrostatic latent images with color toners supplied from toner cartridges 40C, 401, 40Y, and 40K of the respective colors attached to a developer unit 61, and transfers the color toner images in an overlapping manner onto a transfer belt 64 working as an intermediate transfer member. A secondary transfer unit 67 then functions to transfer the four color toner images, which have been transferred to the transfer belt 64 in the overlapping manner, onto a sheet of printing paper that is supplied from a paper cassette 65 and is fed by means of a feeder unit 66. A resulting color image is completed on the printing paper by fusing and fixing the transferred toner images on the printing paper by means of a fixation unit 68. The developer unit 61 is rotatable to form the respective color toner images on the photoreceptor 63. The color laser printer 60 is also provided with a movable connection module 69 that connects with each of storage elements 50C, 50M, 50Y, and 50K of the respective toner cartridges 40C, 40M, 40Y, and 40K attached to the developer unit 61, when the corresponding storage element 50 is located at a lower right position in the drawing. The controller (not shown) of the color laser printer 60 writes the information on the use of the corresponding cartridge into the storage element 50 connecting with the movable connection module 69. The electrical connection of the controller of the color laser printer 60 with each of the storage elements 50 is similar to the electrical connection of the accounting management apparatus 20 with the storage element 50 shown in FIG. 2 and is thus not specifically illustrated nor described here.

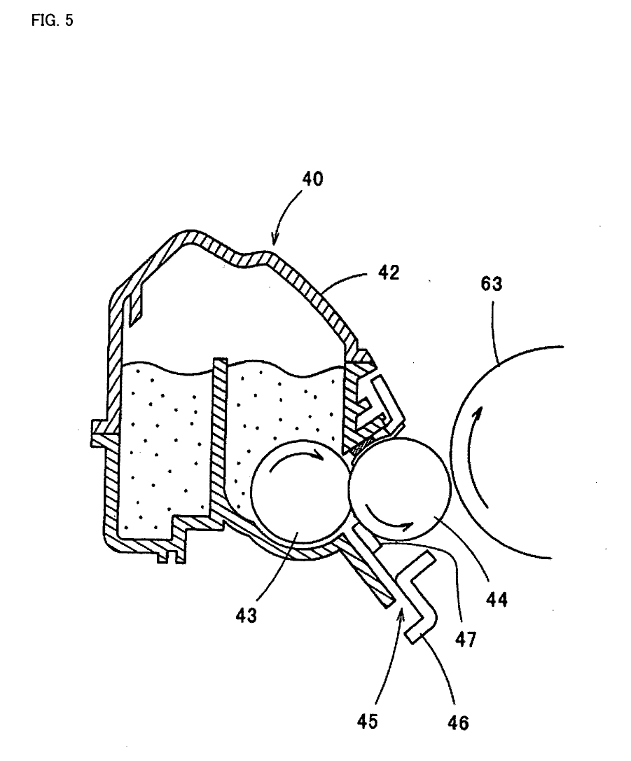

FIG. 5 is a sectional view showing a cross section of the toner cartridge 40. As illustrated, the toner cartridge 40 includes a housing 42 that keeps a toner filled therein, a supply roller 43 that is directly attached to the housing 42 and rotates to support and feed out the toner filled in the housing 42, and a developer roller 44 that rotates to support and further convey the toner fed out by the supply roller 43. The toner cartridge 40 also includes a control blade 45 that has a base end held by a support member 46 and an elastic member 47 attached to the other end thereof. The elastic member 47 works to form the toner held on the developer roller 44 to a thin film of a given uniform thickness. The toner formed to a thin film by the control blade 45 is conveyed by the developer roller 44. The toner is thus stably supplied onto the photoreceptor 63, on which the electrostatic latent image has been formed.

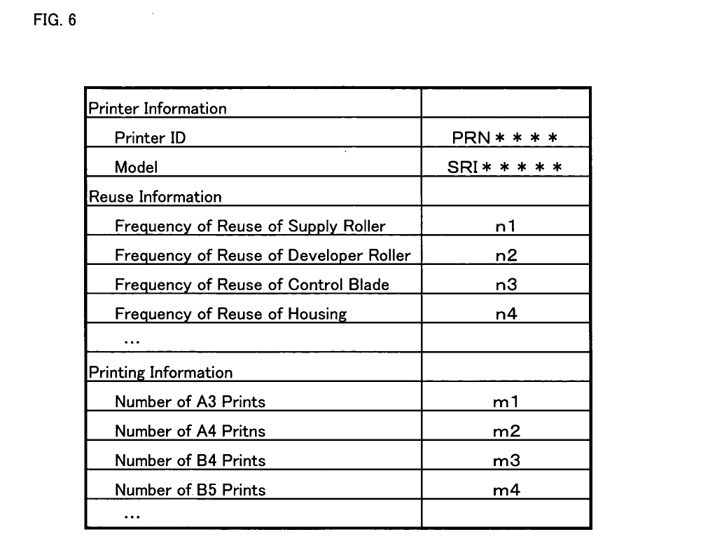

FIG. 6 shows one example of the information stored in the storage element 50 of the toner cartridge 40. In this embodiment, the storage element 50 stores information with regard to the color laser printer 60 having the toner cartridge 40 attached thereto (printer information), information with regard to reuse of each component of the toner cartridge 40 (reuse information), and information with regard to printing by the color laser printer 60 (printing information). The printer information includes an ID allocated to the color laser printer 60 (printer ID) and a model of the color laser printer 60. The reuse information includes the frequencies of reuse of the respective components of the toner cartridge 40, for example, the supply roller 43, the developer roller 44, the control blade 45, and the housing 42. The printing information includes a number of prints with respect to each size of printing paper. The reuse information is written into the storage element 50 at a plant where the collected toner cartridge 40 is recycled for reuse by replacing non-reusable components according to the requirements and filling a new toner in the cartridge 40. The printer information is written into the storage element 50 by the color laser printer 60 when the toner cartridge 40 is attached to and detached from the color laser printer 60. The printing information is written into the storage element 50 by the color laser printer 60 at the time of each printing operation.

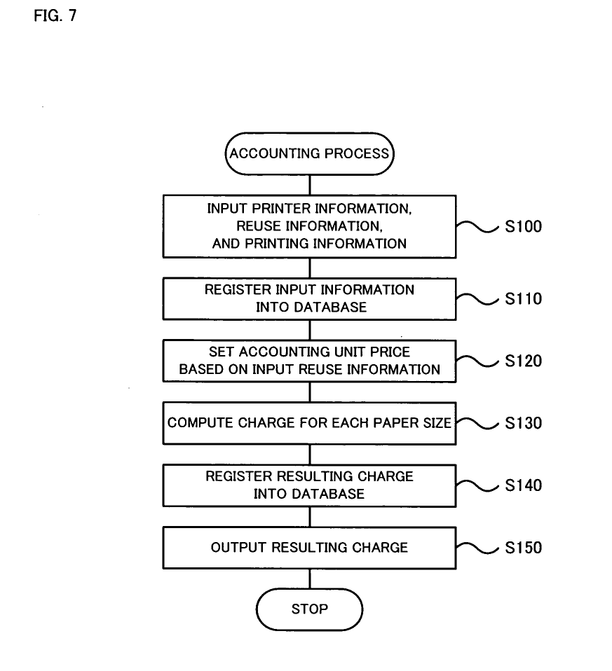

The accounting management apparatus 20 of the embodiment operates as discussed below. FIG. 7 is a flowchart showing an accounting process routine executed by the accounting management apparatus 20 of the embodiment functioning as the accounting process system 27a, when the toner cartridge 40 is attached to the cartridge attachment module 28. When the accounting process routine starts, the accounting management apparatus 20 first inputs the printer information, the reuse information, and the printing information stored in the storage element 50 of the toner cartridge 40 (step S100), and registers the respective pieces of the input information into the accounting database 27b (step S110). The information is input by reading data transmitted in response to output of a read signal from the computer assembly 22 to the read-write controller 54 included in the storage element 50 of the toner cartridge 40 attached to the cartridge attachment module 28.

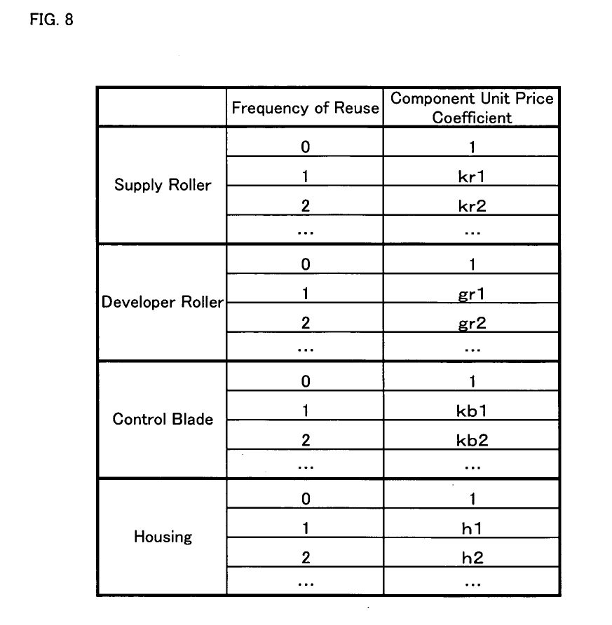

The accounting management apparatus 20 then sets an accounting unit price z with respect to each size of printing paper, based on the input reuse information (step S120). The concrete procedure multiplies a base unit price x with respect to each size of printing paper by a unit price coefficient y of the toner cartridge 40 to calculate the accounting unit price z with respect to the size of printing paper. The unit price coefficient y of the toner cartridge 40 corresponds to the frequencies of reuse of the respective components included in the toner cartridge 40, that is, the supply roller 43, the developer roller 44, the control blade 45, and the housing 42. Namely the unit price coefficient y of the toner cartridge 40 is obtained as a product of component unit price coefficients set for the respective components of the toner cartridge 40. FIG. 8 shows a relation between the frequency of reuse of each component included in the toner cartridge 40 and the component unit price coefficient as an example. In this example, a value ‘1’ is set to the component unit price coefficient with respect to each brand-new component (that is, the frequency of use=0). A smaller value in the value range of 0 to 1 is set to the higher frequency of reuse. The unit price coefficient y accordingly has a smaller value with an increase in frequencies of reuse of the respective components included in the toner cartridge 40. The smaller unit price coefficient y results in the smaller accounting unit price z, which is obtained by multiplying the base unit price x by the unit price coefficient y. When the frequencies of reuse of the supply roller 43, the developer roller 44, the control blade 45, and the housing 42 of the toner cartridge 40 attached to the cartridge attachment module 28 are respectively equal to 1, 2, 0, and 1, the unit price coefficient y is calculated by Equation (1) given below, and the accounting unit price z is expressed by Equation (2) given below:

y=kr1×gr2×1×h1 (1)

z=x×y (2)

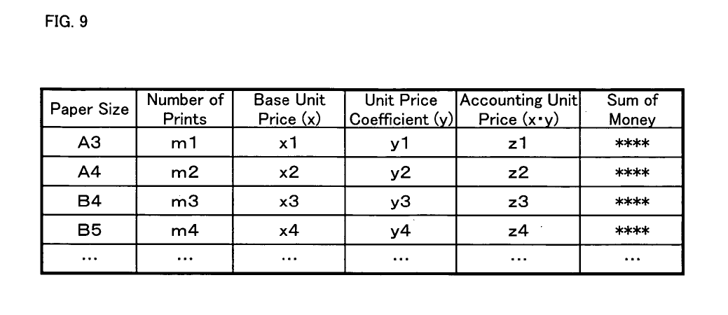

After setting of the accounting unit price z with respect to each size of printing paper, the accounting management apparatus 20 computes a charge for each size of printing paper with the setting of the accounting unit price z (step S130), registers the resulting charge into the accounting database 27b (step S140), and outputs the resulting charge (step S150). This terminates the accounting process routine. One example of the resulting charges is shown in FIG. 9. In the example of FIG. 9, the size of printing paper, the number of prints, the base unit price x, the unit price coefficient y, the accounting unit price z, and the sum of money as the resulting charge are enumerated in the form of a list. The user of the color laser printer 60 is informed of the output resulting charge, based on the printer ID included in the printer information. This series of processing completes the accounting process with respect to the use of the toner filled in the toner cartridge 40, that is, with respect to printing by the color laser printer 60.

As described above, the accounting management apparatus 20 of the embodiment multiplies the base unit price x with respect to each size of printing paper by the unit price coefficient y, which is specified according to the frequencies of reuse of the respective components included in the toner cartridge 40, so as to set the accounting unit price z with respect to the size of printing paper. The accounting management apparatus 20 computes a charge for each size of printing paper as the product of the number of prints with respect to the size of printing paper and the setting of the accounting unit price z. This arrangement ensures reflection of the state of reuse of the respective components included in the toner cartridge 40 on the accounting. The component unit price coefficient is set to have a smaller value with an increase in frequency of reuse of the corresponding component. The user of the color laser printer 60 accordingly desires to use the toner cartridge 40 made of frequently reused components. This arrangement thus encourages reuse of the respective components of the toner cartridge 40, thereby contributing to effective utilization of resources.

The cartridge attachment module 28 and the CPU 23 included in the accounting management apparatus 20 of the embodiment correspond to the information acquisition module of the invention. The CPU 23, the ROM 24, and the RAM 25 functioning as the accounting process system 27a correspond to the charge computation module of the invention.

The accounting management apparatus 20 of the embodiment carries out the accounting process with respect to use of the toner filled in the toner cartridge 40. The accounting management apparatus 20 of the embodiment may be applied to carry out the accounting process with regard to printing. In the latter case, the results of accounting with respect to use of each color toner filled in each color toner cartridge 40 are summed up.

The accounting management apparatus 20 of the embodiment computes the charge, based on the frequencies of reuse of the respective components included in the toner cartridge 40. One possible modification may compute the charge, based on the frequency of reuse of the whole toner cartridge 40. This modified arrangement may or may not take into account the frequencies of reuse of the respective components.

The accounting management apparatus 20 of the embodiment computes the charge, based on the frequencies of reuse of the respective components included in the toner cartridge 40 and the number of prints with regard to each size of printing paper. Another possible modification may compute the charge, based on the frequencies of reuse of the respective components included in the toner cartridge 40 and the consumption of each toner. In the embodiment discussed above, the toner cartridge 40 has the supply roller 43, the developer roller 44, the control blade 45, and the housing 42 as its components. The reuse information regards the frequencies of reuse of the respective components. When the toner cartridge has an OPC unit as its component, the reuse information may regard the frequency of reuse of the OPC or a charged body, in addition to the frequencies of reuse of the other respective components.

The accounting management apparatus 20 of the embodiment sets an identical value to the base unit price x with regard to each size of printing paper, irrespective of the number of prints. One possible modification may set a smaller value to the base unit price x with an increase in number of prints. Another possible modification may set a fixed value to the base unit price x in each range of the number of prints. A smaller value may be set to the base unit price x in a range of a greater number of prints.

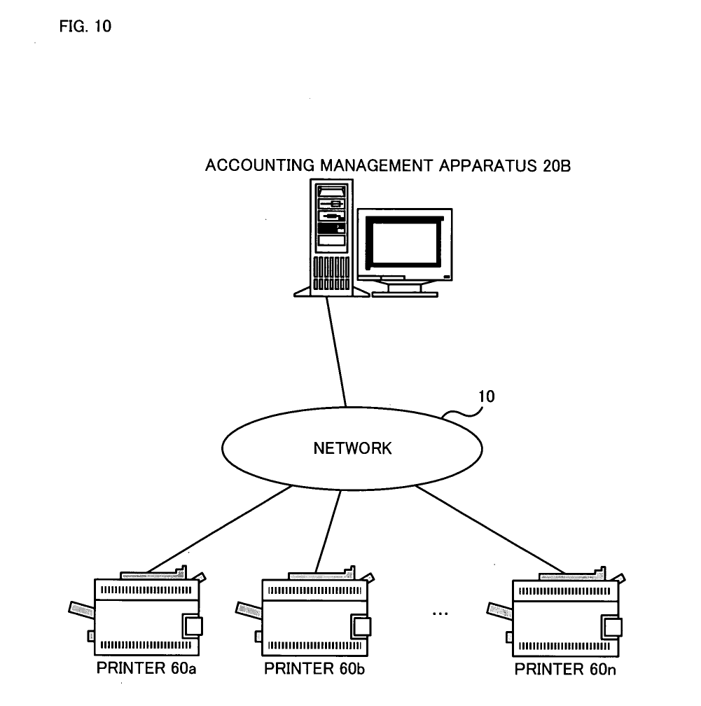

The accounting management apparatus 20 of the embodiment executes the accounting process when the toner cartridge 40 collected from the color laser printer 60 is attached to the cartridge attachment module 28. As in the case of an accounting management system shown in FIG. 10, an accounting management apparatus 20B may be connected with multiple color laser printers 60a through 60n via a network 10, such as the Internet, and execute the accounting process with respect to each of the multiple color laser printers 60a through 60n. In this modified structure, the accounting management apparatus 20B directly inputs the printer information and the printing information from each of the color laser printers 60a through 60b, while inputting the reuse information, which has been read from the storage element 50 of the toner cartridge 40 via the movable connection module 69 into each of the color laser printers 60a through 60n, from each of the color laser printers 60a through 60n via the network 10. This arrangement allows for execution of the accounting process without collection of the toner cartridge 40. In this modified structure, the accounting process may not be carried out with respect to use of the toner filled in each toner cartridge 40. The procedure may compute the charges for the use of the color toners filled in the respective color toner cartridges 40C, 40M, 40Y, and 40K with regard to each printing operation on the printing paper and sum up the charges as account with respect to the printing operation. The accounting management apparatus 20B may totalize the account at intervals of a preset time period (for example, every month) and output the resulting total account to each of the color laser printers 60a through 60n via the network 10.

In the above embodiment, the accounting management apparatus 20 carries out the accounting process with respect to use of the toner filled in the toner cartridge 40. In one possible modification, the color laser printer 60 may have the functions of the accounting management apparatus 20.

The embodiment regards the accounting management apparatus 20 that computes the charge, based on the frequencies of reuse with regard to the respective components of the toner cartridge 40. The technique of the invention is also attained by an accounting process method that computes the charge, based on the frequencies of reuse with regard to the respective components of the toner cartridge 40. Another application of the invention is a program that causes a computer to function as the accounting management apparatus 20 of the embodiment. In the application of the program, the respective steps of the accounting process shown in the flowchart of FIG. 7 are programmed in an adequate programming language and are installed in the computer.

The above embodiment is to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

What is claimed is:

1. An accounting management apparatus that manages accounting with respect to image formation by an image formation device, which uses a recording agent from a recording agent cartridge having a storage element to form an image including letters and characters on a medium like paper, said accounting management apparatus comprising:
an information acquisition module that acquires accounting information which is stored in the storage element of said recording agent cartridge, the accounting information including cartridge information with regard to said recording agent cartridge and image formation information with regard to image formation carried out by said image formation device with the recording agent from said recording agent cartridge; and
a charge computation module that computes a charge, based on the acquired cartridge information and image formation information.

2. An accounting management apparatus in accordance with claim 1, wherein the cartridge information includes reuse information regarding reuse of a main body and components of said recording agent cartridge, and
said charge computation module computes the charge, based on the reuse information.

3. An accounting management apparatus in accordance with claim 2, wherein said charge computation module computes the charge in such a manner as to lower the charge with an increase in frequency of reuse with regard to the main body of said recording agent cartridge.

4. An accounting management apparatus in accordance with claim 2, wherein said charge computation module computes the charge in such a manner as to lower the charge with an increase in number of reused components among all the components of said recording agent cartridge.

5. An accounting management apparatus in accordance with claim 1, wherein the image formation information includes a numerical quantity of image formation, and
said charge computation module computes the charge in such a manner as to lower the charge with an increase in numerical quantity of image formation.

6. An accounting management apparatus in accordance with claim 1, wherein said information acquisition module acquires the image formation information from the storage element of said recording agent cartridge.

7. An accounting management apparatus in accordance with claim 6, said accounting management apparatus further comprising:
a connector module that is connectable with the storage element of said recording agent cartridge,
wherein said information acquisition module acquires information used for accounting from the storage element of said recording agent cartridge connecting with said connector module.

8. An accounting management apparatus in accordance with claim 1, wherein said information acquisition module acquires the cartridge information and the image formation information, which are stored in the storage element of said recording agent cartridge attached to said image formation device, from said image formation device connecting with said accounting management apparatus via a communication line.

9. An accounting management apparatus in accordance with claim 8, wherein multiple recording agent cartridges are attached to said image formation device, and
said charge computation module computes the charge, based on multiple pieces of the cartridge information acquired from respective storage elements of said multiple recording agent cartridges attached to said image formation device.

10. An accounting process method that manages accounting with respect to image formation by an image formation device, which uses a recording agent from a recording agent cartridge having a storage element to form an image including letters and characters on a medium like paper, said accounting process method comprising the steps of:
(a) acquiring accounting information, the accounting information including cartridge information with regard to said recording agent cartridge, which is stored in the storage element of said recording agent cartridge, and image formation information with regard to image formation carried out by said image formation device with the recording agent from said recording agent cartridge; and
(b) computing a charge, based on the acquired cartridge information and image formation information.

11. An accounting process method in accordance with claim 10, wherein the cartridge information includes reuse information regarding reuse of a main body and components of said recording agent cartridge, and
said step (b) computes the charge, based on the reuse information.

12. An accounting process method in accordance with claim 11, wherein said step (b) computes the charge in such a manner as to lower the charge with an increase in frequency of reuse with regard to the main body of said recording agent cartridge.

13. An accounting process method in accordance with claim 11, wherein said step (b) computes the charge in such a manner as to lower the charge with an increase in number of reused components among all the components of said recording agent cartridge.

14. An accounting process method in accordance with claim 10, wherein the image formation information includes a numerical quantity of image formation, and
said step (b) computes the charge in such a manner as to lower the charge with an increase in numerical quantity of image formation.

15. An accounting process method in accordance with claim 10, wherein said step (a) acquires the image formation information from the storage element of said recording agent cartridge.

16. An accounting process method in accordance with claim 10, wherein said step (a) acquires the cartridge information and the image formation information, which are stored in the storage element of said recording agent cartridge attached to said image formation device, from said image formation device connecting with said accounting management apparatus via a communication line.

17. An accounting process method in accordance with claim 16, wherein multiple recording agent cartridges are attached to said image formation device, and
said step (b) computes the charge, based on multiple pieces of the cartridge information acquired from respective storage elements of said multiple recording-agent cartridges attached to said image formation device.
